(19) United States
(12) Patent Application Publication
(10) Pub. No.: US 2013/0120450 A1
(43) Pub. Date: May 16, 2013

(54) METHOD AND APPARATUS FOR PROVIDING AUGMENTED REALITY TOUR PLATFORM SERVICE INSIDE BUILDING BY USING WIRELESS COMMUNICATION DEVICE

(71) Applicants: Ig Jae KIM, Seoul (KR); Jaewon KIM, Seoul (KR); Heedong KO, Seoul (KR)

(72) Inventors: Ig Jae KIM, Seoul (KR); Jaewon KIM, Seoul (KR); Heedong KO, Seoul (KR)

(21) Appl. No.: 13/676,153

(22) Filed: Nov. 14, 2012

(30) Foreign Application Priority Data
Nov. 14, 2011 (KR) 10-2011-0118535

(51) Int. Cl. G09G 5/22

(52) U.S. Cl. CPC G09G 5/22
USPC 345/633

(57) ABSTRACT

A method of providing an augmented reality tour platform service for the inside of a building by using a wireless communication device. The method includes: acquiring an image of the building from the wireless communication device; collecting information associated with the acquired image; extracting a candidate building group from a previously established database on the basis of the acquired image and the collected information; specifying a building matching the acquired image from among the extracted candidate building group; and transmitting information regarding the inside of the specified building to the wireless communication device.

### CROSS-REFERENCE TO RELATED PATENT APPLICATION

This application claims the benefit of Korean Patent Application No. 10-2011-0118535, filed on Nov. 14, 2011, in the Korean Intellectual Property Office, the disclosure of which is incorporated herein in its entirety by reference.

### BACKGROUND OF THE INVENTION

1. Field of the Invention

The present invention relates to a method and apparatus for providing an augmented reality tour platform service making an augmented reality tour possible inside a building by using a wireless communication device, and more particularly, to a method and apparatus for receiving, through a device capable of performing wireless communication, information regarding a building navigated using the device even in a state where a user does not actually enter into the building.

2. Description of the Related Art

Augmented reality is an extension of virtual reality and is a computer graphic scheme for composing virtual objects into an actual environment to view the virtual objects as if they were objects existing in the actual environment. Augmented reality complements the real world by representing virtual images to overlap the real world and provides images in which an actual environment and virtual objects are mixed. Thus, additional information that is difficult to acquire only in a real world environment may be provided to supplement the real world, thereby providing more information in a realistic manner. Accordingly, augmented reality technology is applicable to various actual environments and is particularly highlighted as next-generation display technology suitable for a ubiquitous environment.

If information in which a user is interested is provided at the right time by converging Location-Based Services (LBS) technology and wireless Internet service technology, convenience to the user using a wireless communication device or the like may be maximized.

### SUMMARY OF THE INVENTION

The present invention provides a method and apparatus for providing an augmented reality tour platform service for the inside of a building by using a wireless communication device.

According to an aspect of the present invention, there is provided a method of providing information regarding a building to a wireless communication device, the method including: acquiring an image of the building from the wireless communication device; collecting information associated with the acquired image; and extracting a candidate building group from a previously established database on the basis of the acquired image and the collected information. The method may further include: specifying a building matching the acquired image from among the extracted candidate building group; and transmitting information regarding the specified building to the wireless communication device.

According to another aspect of the present invention, there is provided a method of implementing an augmented reality tour inside a building by using a wireless communication device, the method including: acquiring an image of the building; transmitting the acquired image to a server; receiving information regarding a building specified as matching the acquired image from among a candidate building group from the server; and displaying the information regarding the specified building.

According to another aspect of the present invention, there is provided a server for providing information regarding a building to a wireless communication device, the server including: a data collector for acquiring an image of the building from the wireless communication device and collecting information associated with the acquired image; an information processor for extracting a candidate building group from a previously established database on the basis of the acquired image and the collected information and specifying a building matching the acquired image from among the extracted candidate building group; and a communication unit for transmitting information regarding the specified building to the wireless communication device.

According to another aspect of the present invention, there is provided a wireless communication device for an augmented reality tour inside a building, the wireless communication device including: an image acquisition unit for acquiring an image of a building; a communication unit for transmitting the image of the building, which is acquired by the image acquisition unit, to a server and receiving information regarding the building from the server; a controller for controlling the received information regarding the building; and a display unit for displaying the received information regarding the building.

According to another aspect of the present invention, there is provided a computer-readable recording medium storing a computer-readable program for executing the methods described above.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of providing information regarding a building to a wireless communication device, according to an embodiment of the present invention;

FIG. 2 is a flowchart illustrating a method of implementing an augmented reality tour inside a building by using a wireless communication device, according to an embodiment of the present invention;

FIG. 3 is an image of a building, which is acquired through a wireless communication device.

FIG. 4 is an image showing a candidate building group extracted from a previously established database;

FIG. 5 is an image showing that a building matching an image acquired through a wireless communication device from among an extracted candidate building group is specified;

FIG. 6 is an image showing that an augmented reality tour inside a building is implemented by using a wireless communication device;

FIG. 7 is a block diagram of a server for providing information regarding a building to a wireless communication device, according to an embodiment of the present invention;

FIG. 8 is a block diagram of a wireless communication device for an augmented reality tour inside a building, according to an embodiment of the present invention; and

FIG. 9 is a block diagram of a controller of a wireless communication device, according to an embodiment of the present invention.

### DETAILED DESCRIPTION OF THE INVENTION

The merits and features of the present invention, and a method for achieving them will be clear by referring to the embodiments described in detail below together with the accompanying drawings. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art. The present invention is only defined by the scope of the claims, and like reference numerals denote like elements throughout the specification.

In the following description, well-known functions or constructions are not described in detail if it is thought that they would obscure the invention with unnecessary detail. However, the terminology described below is defined considering functions in the present invention and may vary according to a user, an intention of an operator, or a custom. Thus, the definitions should be understood based on all the contents of the specification.

Expressions such as “at least one of,” when preceding a list of elements, modify the entire list of elements and do not modify the individual elements of the list.

The present invention is to provide a method and apparatus for allowing a user to be able to look around the inside of a building even without directly entering inside the building, and for example, to implement a method and apparatus for providing a platform service capable of looking around the inside of a building of interest through a screen of a wireless communication device by moving the wireless communication device or intuitively manipulating a touch pad when the user navigates inside the building of interest by using the wireless communication device.

That is, according to the present invention, the user may intuitively look around the inside of a building around the user through the wireless communication device even without directly entering into the building. For example, when the user selects a restaurant or a shopping mall from those around the user, the user may reduce a moving time and efforts to directly enter into the inside of a building by comparing the insides of restaurants or shopping malls around a current location of the user.

However, the objectives of the present invention are not limited thereto, and other objectives not described above will be clearly understood by those of ordinary skill in the art from the disclosure below.

The embodiments of the present invention will now be described in detail with reference to the accompanying drawings.

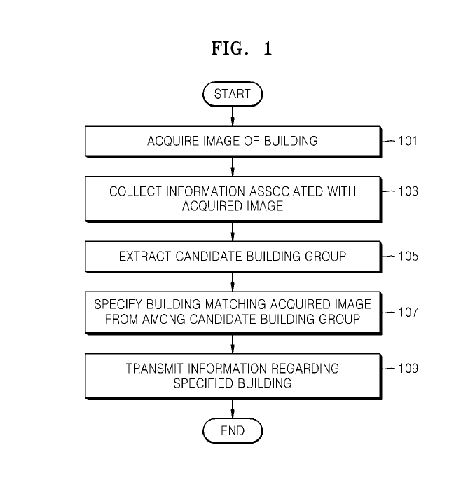

FIG. 1 is a flowchart illustrating a method of providing information regarding a building to a wireless communication device 800 (refer to FIG. 8), according to an embodiment of the present invention.

Referring to FIG. 1, the method may include: acquiring an image of the building from the wireless communication device 800 (operation 101); collecting information associated with the acquired image (operation 103); and extracting a candidate building group from a previously established database on the basis of the acquired image and the collected information (operation 105). The method may further include: specifying a building matching the acquired image from among the extracted candidate building group (operation 107); and transmitting information regarding the specified building to the wireless communication device 800 (operation 109).

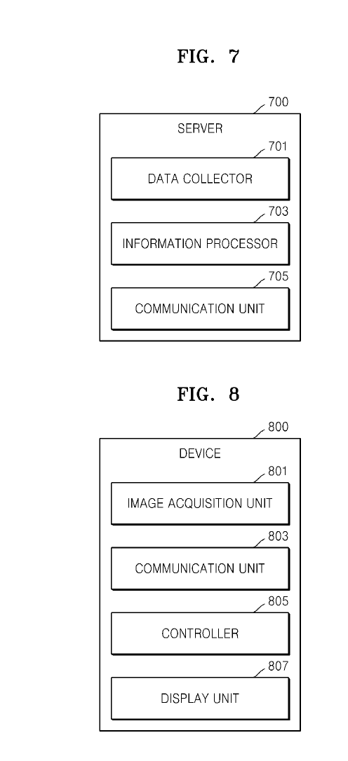

The acquiring of the image of the building from the wireless communication device 800 (operation 101) may further include receiving the image of the building, which is transmitted from the wireless communication device 800, from a communication unit 705 of a server 700 (refer to FIG. 7).

The information associated with the acquired image may include Global Positioning System (GPS) information, map information, and so forth, and may be included in the previously established database or exist as an external database. The external database may include Street View (Google), Road View (Daum), Store View (Daum), Street View (Naver) systems, etc. recently established by portal companies (Google, Daum, Naver, etc.) in Korea and abroad.

The previously established database may include an image database. The image database may include an outside image, an inside panoramic image, and so forth of each building.

The previously established database may also include information regarding each building. The information regarding each building may include information regarding the inside of each building. The information regarding the inside of each building may include an interior image of a corresponding building and information regarding a service provided in the corresponding building (e.g., menu information in a case of a restaurant, review information made by users, etc.). The interior image of the corresponding building may be included in the image database in a form of a panoramic image of the inside of the corresponding building. The information regarding the inside of each building may be used by a user for a service reservation by being linked to an online reservation system.

The extracting of the candidate building group from the previously established database on the basis of the acquired image and the collected information (operation 105) may further include setting a candidate building extraction area, which is performed by the server 700 on the basis of GPS information, map information, and so forth. The candidate building extraction area may be set by previously setting an extraction radius or may be set in real-time by the user.

The specifying of the building matching the acquired image from among the candidate building group extracted by the server 700 (operation 107) may include specifying a building corresponding to the acquired image, i.e., a building in which the user is interested, by matching the acquired image of the building with images of buildings belonging to the candidate building group. The acquired image of the building may match with images of buildings belonging to the candidate building group using correlations between images.

The method may further include transmitting information regarding the specified building to a communication unit 803 of the wireless communication device 800 via the communication unit 705 of the server 700 (operation 109).

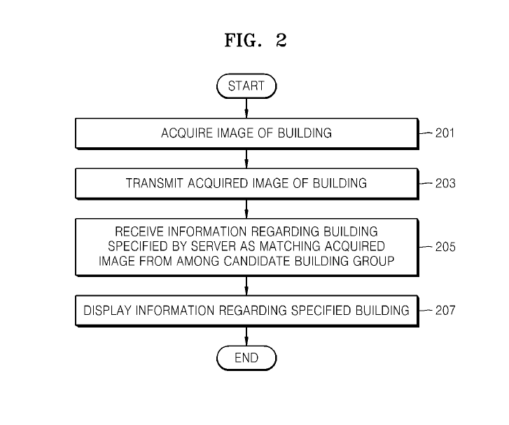

FIG. 2 is a flowchart illustrating a method of implementing an augmented reality tour inside a building by using the wireless communication device 800 (refer to FIG. 8), according to an embodiment of the present invention.

Referring to FIG. 2, the method may include: acquiring an image of the building (operation 201); transmitting the acquired image to the server 700 (refer to FIG. 7) (operation 203); and receiving information regarding a building specified as matching the acquired image from among a candidate building group from the server 700 (operation 205). The method may further include displaying the information regarding the specified building (operation 207).

The acquiring of the image of the building (operation 201) may include acquiring an image by photographing a building in which a user is interested. Alternatively, the acquiring of the image of the building (operation 201) may include acquiring the image of the building by selecting an outside image of the building, which is included in a previously established database.

The acquired image may be transmitted to the server 700 via the communication unit 803 (refer to FIG. 8) of the wireless communication device 800 in operation 203.

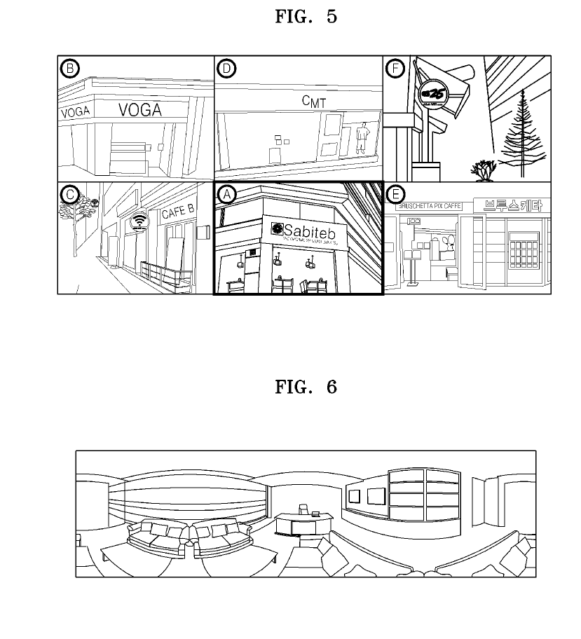

In operation 205, information regarding a building specified as matching the acquired image from among a candidate building group by the server 700 may be received from the server 700. The candidate building group may be extracted from a previously established database in the server 700. Outside images of buildings belonging to the candidate building group may be represented in the form of thumbnails. In addition, as shown in FIG. 5, the building matching the acquired image from among the candidate building group may be highlighted using a border added to a corresponding image.

The information regarding the building may include an interior image of the building and information regarding a service provided in the building (e.g., menu information in a case of a restaurant, review information made by users, etc.).

In operation 207, the information regarding the specified building may be displayed through a display unit 807 (refer to FIG. 8) of the wireless communication device 800.

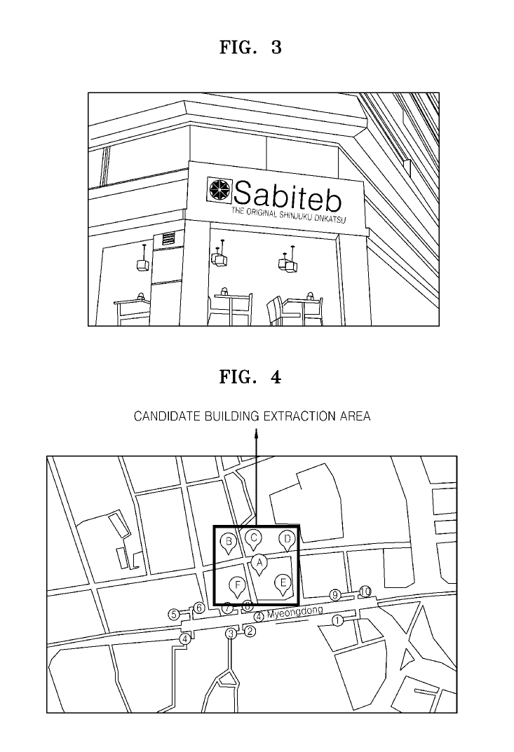

FIG. 3 is an image of a building, which is acquired through the wireless communication device 800 (refer to FIG. 8).

The acquiring of the image of the building may include acquiring an image by photographing a building in which a user is interested. Alternatively, the acquiring of the image of the building may include acquiring the image of the building by selecting an outside image of a corresponding building, which is included in a previously established database.

FIG. 4 is an image showing a candidate building group extracted from a previously established database.

Referring to FIG. 4, an area around a building in which a user is interested may be set as a candidate building group area according to a predetermined criterion on the basis of GPS information, map information, and so forth. The predetermined criterion for the candidate building group area, such as an extraction radius, may be set in advance, or may be set in real-time by the user.

FIG. 5 is an image showing that a building matching an image acquired through the wireless communication device 800 (refer to FIG. 8) from among an extracted candidate building group is specified.

As shown in FIG. 5, outside images of buildings A, B, C, D, E, and F belonging to the extracted candidate building group may be displayed on the wireless communication device 800 in the form of thumbnails. Alternatively, a candidate building group extracted by the server 700 (refer to FIG. 7) may be displayed on the wireless communication device 800 in a list form. The building matching the acquired image from among the candidate building group may be represented by emphasizing a border of the image or magnifying the image of the building to be specified (refer to the building A of FIG. 5).

FIG. 6 is an image showing that an augmented reality tour inside a building is implemented by using the wireless communication device 800 (refer to FIG. 8).

Information regarding a building in which a user is interested may be provided to the user through the wireless communication device 800. The information regarding the building includes information regarding the inside of the building in which the user is interested, and the information regarding the inside of the building may include at least one of an inside panoramic image of the building and information associated with services provided in the building.

The information regarding the building in which the user is interested, i.e., information regarding a building specified from among a candidate building group may vary according to a motion of the wireless communication device 800.

The information regarding the inside of the building may include an interior image of the building and information regarding services provided in the building (e.g., menu information in the case of a restaurant, review information provided by users, etc.). The interior image of the building may be included in the information regarding the inside of the building in the form of a panoramic image of the inside of the building.

That is, the interior image of the building may be changed in real-time in response to a motion of the wireless communication device 800 and provided in the form of a panoramic image. The motion of the wireless communication device 800 may include a self-motion of the wireless communication device 800 and a motion of a pointing point of the wireless communication device 800. The pointing point of the wireless communication device 800 may indicate a reference point of the information regarding the inside of the building.

The information regarding the inside of the building may also be changed in response to an input signal of the user to the wireless communication device 800 and provided to the user. That is, through a manipulation on a touch pad by the user, the information regarding the inside of the building may be changed in response to the manipulation by the user and provided to the user. According to whether a signal input by the user is detected, a touch pad (not shown) capable of controlling functions of the wireless communication device 800 may be included in the wireless communication device 800.

FIG. 7 is a block diagram of the server 700 for providing information regarding the inside of a building to the wireless communication device 800 (refer to FIG. 8), according to an embodiment of the present invention.

Referring to FIG. 7, the server 700 includes a data collector 701, an information processor 703, and a communication unit 705.

The data collector 701 may acquire an image of a building from the wireless communication device 800 and collect information associated with the acquired image.

The information associated with the acquired image may include GPS information, map information, and so forth, and may be included in a previously established database or exist as an external database.

The information processor 703 may extract a candidate building group from the previously established database on the basis of the acquired image and the collected information and specify a building matching the acquired image from the extracted candidate building group.

The previously established database may include an image database, which may include an outside image and an inside panoramic image of each building.

In addition, the previously established database may include information regarding the inside of each building. The information regarding the inside of each building may include an interior image of the building and information regarding services provided in the building (e.g., menu information in a case of a restaurant, review information provided by users, etc.). The interior image of the building may be included in the image database in the form of a panoramic image of the inside of the building.

The communication unit 705 may acquire (receive) an image of a building in which a user is interested from the wireless communication device 800. The communication unit 705 may also receive information associated with the acquired image from a database located outside the server 700. The communication unit 705 may also transmit information regarding the building in which the user is interested to the wireless communication device 800.

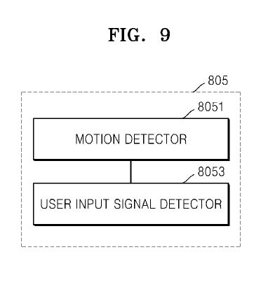

FIG. 8 is a block diagram of the wireless communication device 800 for an augmented reality tour inside a building, according to an embodiment of the present invention. FIG. 9 is a block diagram of a controller 805 of the wireless communication device 800, according to an embodiment of the present invention.

Referring to FIG. 8, the wireless communication device 800 may include an image acquisition unit 801, the communication unit 803, the controller 805, and the display unit 807.

A user may acquire an image of a building of interest by using the image acquisition unit 801. The user may directly photograph the building of interest to acquire the image of the building.

The communication unit 803 may transmit the image of the building, which is acquired by the image acquisition unit 801, to the server 700 and receive information regarding the inside of the building from the server 700.

The controller 805 may control the information regarding the inside of the building, which is received from the server 700. Referring to FIG. 9, the controller 805 may include a motion detector 8051 and a user input signal detector 8053, and accordingly, the wireless communication device 800 may strengthen handling of the wireless communication device 800 and an interaction with the information regarding the inside of the building through the motion detector 8051 and the user input signal detector 8053.

The motion detector 8051 may include various types of sensors for detecting a motion, such as a 3-axes motion sensor, a rotation sensor, a gyro sensor, and so forth, and may detect by using the sensors whether the wireless communication device 800 moves. In other words, the controller 805 may change an interior image of a building in real-time in response to a motion of the wireless communication device 800, which is detected by the motion detector 8051, and provide the changed image to the user.

The user input signal detector 8053 may detect the presence/absence of a signal input by the user. That is, for example, when a user input signal is detected in response to a manipulation of a touch pad (not shown) of the wireless communication device 800 by the user, the controller 805 may change and provide information regarding the inside of the building to the user in response to an operation corresponding to the manipulation on the touch pad according to the user input signal. The touch pad capable of generating a user input signal may be included in the wireless communication device 800.

The display unit 807 may display the image of the building in which the user is interested, which is acquired by the image acquisition unit 801. The display unit 807 may also display a candidate building group extracted by the server 700. The display unit 807 may also display information regarding the building in which the user is interested from among the candidate building group.

The wireless communication device 800 includes a wireless communication capable electronic device in a broad sense and, for example, may include a personal digital assistant (PDA), a smart phone, or the like.

As described above according to the present invention, if a user can intuitively perceive the inside of a building even though the user does not directly enter into buildings around a current location of the user, an actual moving distance of the user may be reduced, thereby providing convenience to the user. In addition, since there is no temporal limitation of when the user may perceive information regarding a building, the utilization of information in which the user is interested may further increase.

The embodiments of the present invention may be written as computer programs and may be implemented in general-use digital computers that execute the programs using a computer-readable recording medium. Examples of the computer-readable recording medium include storage media such as magnetic storage media (e.g., ROM, floppy disks, hard disks, etc.) and optical recording media (e.g., CD-ROMs, or DVDs).

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in a descriptive sense only and not for purposes of limitation. Therefore, the scope of the present invention is defined not by the detailed description of the present invention but by the appended claims, and all differences within the scope of the present invention will be construed as being included in the present invention.

What is claimed is:

1. A method of providing information regarding a building to a wireless communication device, the method comprising:
acquiring an image of the building from the wireless communication device;
collecting information associated with the acquired image;
extracting a candidate building group from a previously established database on the basis of the acquired image and the collected information;
specifying a building matching the acquired image from among the extracted candidate building group; and
transmitting information regarding the specified building to the wireless communication device.

2. The method of claim 1, wherein the information associated with the acquired image comprises Global Positioning System (GPS) information.

3. The method of claim 1, wherein the extracting of the candidate building group comprises setting a candidate building extraction area by using map information of the previously established database.

4. The method of claim 3, wherein the extracting of the candidate building group comprises editing a list of a plurality of buildings in the candidate building extraction area.

5. The method of claim 1, wherein the specifying of the building comprises specifying the building by matching the acquired image with the candidate building group.

6. The method of claim 1, wherein the information regarding the specified building includes information regarding the inside of the specified building, and
the information regarding the inside of the specified building includes at least one of a panoramic image of the inside of the specified building and information associated with services provided in the specified building.

7. A method of implementing an augmented reality tour inside a building by using a wireless communication device, the method comprising:
acquiring an image of the building;
transmitting the acquired image to a server;
receiving information regarding a building specified as matching the acquired image from among a candidate building group from the server; and
displaying the information regarding the specified building.

8. The method of claim 7, wherein the acquiring of the image of the building comprises acquiring the image by photographing the building.

9. The method of claim 7, wherein the information regarding the specified building includes information regarding the inside of the building specified by the server from among the candidate building group extracted by the server, and
the information regarding the inside of the specified building includes at least one of a panoramic image of the inside of the specified building and information associated with services provided in the specified building.

10. The method of claim 9, wherein the information regarding the inside of the specified building is changed in response to a motion of the wireless communication device.

11. The method of claim 9, wherein the information regarding the inside of the specified building is changed in response to a user input signal for the wireless communication device.

12. An apparatus for providing information regarding a building to a wireless communication device, the apparatus comprising:
a data collector for acquiring an image of the building from the wireless communication device and collecting information associated with the acquired image;
an information processor for extracting a candidate building group from a previously established database on the basis of the acquired image and the collected information and specifying a building matching the acquired image from among the extracted candidate building group; and
a communication unit for transmitting information regarding the specified building to the wireless communication device.

13. The apparatus of claim 12, wherein the information associated with the acquired image comprises Global Positioning System (GPS) information.

14. The apparatus of claim 12, wherein the information processor sets a candidate building extraction area by using map information of the previously established database.

15. The apparatus of claim 14, wherein the information processor edits a list of a plurality of buildings in the candidate building extraction area.

16. The apparatus of claim 12, wherein the information processor specifies the building by matching the acquired image with the candidate building group.

17. The apparatus of claim 12, wherein the information regarding the specified building includes information regarding the inside of the specified building, and
the information regarding the inside of the specified building includes at least one of a panoramic image of the inside of the specified building and information associated with services provided in the specified building.

18. The apparatus of claim 12, wherein the communication unit receives the acquired image of the building from the wireless communication device.

19. A wireless communication device for an augmented reality tour inside a building, the wireless communication device comprising:
an image acquisition unit for acquiring an image of a building;
a communication unit for transmitting the image of the building, which is acquired by the image acquisition unit, to a server and receiving information regarding the building from the server;
a controller for controlling the received information regarding the building; and
a display unit for displaying the received information regarding the building.

20. The wireless communication device of claim 19, wherein the image acquisition unit acquires the image by photographing the building.

21. The wireless communication device of claim 19, wherein the information regarding the specified building includes information regarding the inside of the building specified by the server from among the candidate building group extracted by the server, and
the information regarding the inside of the specified building includes at least one of a panoramic image of the inside of the specified building and information associated with services provided in the specified building.

22. The wireless communication device of claim 19, wherein the controller further comprises a motion detector for detecting a motion of the wireless communication device, which changes information regarding the inside of the specified building.

23. The wireless communication device of claim 19, wherein the controller further comprises a user input signal detector for detecting a user input signal for changing the information regarding the inside of the specified building.

24. A computer-readable recording medium storing a computer-readable program for executing the method of claim 1.
